(19) United States
(12) Patent Application Publication
(10) Pub. No.: US 2026/0111471 A1
(43) Pub. Date: Apr. 23, 2026

(54) SYSTEM AND METHODS FOR PERFORMING SEARCH OF API DATA

(71) Applicant: Shopify Inc., Ottawa (CA)

(72) Inventors: Richard Jeffrey KEHRES, Waterloo (CA); Gasser ALY, Longueuil (CA)

(73) Assignee: Shopify Inc., Ottawa (CA)

(21) Appl. No.: 18/984,463

(22) Filed: Dec. 17, 2024

Related U.S. Application Data
(60) Provisional application No. 63/708,439, filed on Oct. 17, 2024.

(51) Int. Cl. G06F 16/334; G06F 16/338

(52) U.S. Cl. CPC G06F 16/3347; G06F 16/338

(57) ABSTRACT

A computer-implemented method is disclosed. The method includes: receiving a search query for a first application programming interface (API); generating an embedding of the search query; performing a search of the first API by using the search query embedding to search a set of first vector embeddings generated by: obtaining API schema of the first API; determining a set of all API paths associated with the first API based on the API schema, each API path defining a root API object and a sequence of one or more field elements of the API ending in a terminal field element; obtaining, using a large language model (LLM), natural language descriptions of each API path associated with the first API; and generating the first vector embeddings based on the obtained descriptions, and providing results of the search, the results identifying one or more API paths similar to the search query.

### CROSS-REFERENCE TO RELATED APPLICATION

The present application claims the benefit of U.S. Provisional Patent Application No. 63/708,439 filed on Oct. 17, 2024, the contents of which are incorporated herein by reference.

### TECHNICAL FIELD

The present disclosure relates to query processing systems and, more particularly, to techniques that leverage use of large language models (LLMs) for performing search of application programming interface (API) data.

### BACKGROUND

API documentation comprises human-readable instructions for using, integrating, or otherwise interacting with an API. API docs (or description documents) include detailed information about an API's available endpoints (i.e., paths and methods), resources (e.g., objects), methods, parameters, and the like. Specifically, API docs provide definitions/descriptions of standard API objects as well as various fields and connections that are associated with the objects.

Navigating complex and extensive API documentation to locate desired API resources may pose a significant burden on users of the API. For a non-technical user with limited knowledge of an API and its defined objects, types, variables, methods, etc., searching for data in API documentation is a complicated task that can hamper effective use and integration of the API.

### BRIEF DESCRIPTION OF THE DRAWINGS

Reference will now be made, by way of example only, to the accompanying drawings which show example embodiments of the present application, and in which:

FIG. 1 is a schematic diagram of an example operating environment in which embodiments of the present disclosure may be implemented;

FIG. 2 is a graphical representation of an example API path and its constituent elements;

FIG. 3 shows, in flowchart form, an example method for indexing API paths data;

FIG. 4 shows, in flowchart form, another example method for indexing API paths data;

FIG. 5 shows, in flowchart form, an example method for performing search of API data using offline indexing;

FIG. 6 shows, in flowchart form, an example method for performing search of API data using online indexing;

FIG. 7 is a block diagram of an example computing system, which may be used to implement examples of the present disclosure;

FIG. 8 is a block diagram of a simplified convolutional neural network, which may be used in examples of the present disclosure; and

FIG. 9 is a block diagram of a simplified transformer neural network, which may be used in examples of the present disclosure;

Like reference numerals are used in the drawings to denote like elements and features.

### DETAILED DESCRIPTION OF IMPLEMENTATIONS

In an aspect, the present application discloses a computer-implemented method. The method may include: receiving a search query for a first application programming interface (API); generating an embedding of the search query; performing a search of the first API by using the search query embedding to search a set of first vector embeddings generated by: obtaining API schema of the first API; determining a set of all API paths associated with the first API based on the API schema, each API path defining a root API object and a sequence of one or more field elements of the API ending in a terminal field element; obtaining, using a large language model (LLM), natural language descriptions of each API path associated with the first API; and generating the first vector embeddings based on the obtained descriptions, and providing results of the search, the results identifying one or more API paths similar to the search query.

In some implementations, performing the search may include comparing the search query embedding to the first vector embeddings using a vector similarity search algorithm.

In some implementations, the method may further include storing, in a vector database, each first vector embedding in association with a corresponding full-text path.

In some implementations, performing the search may include identifying a first one of the API paths with the highest likelihood to contain a field element corresponding to the search query.

In some implementations, the search query may be received via a graphical user interface of an integrated development environment.

In some implementations, the method may further include: for each API path, determining, using an LLM, one or more candidate search queries relating to the API path; and generating second vector embeddings of the candidate search queries, and each first vector embedding and second vector embedding may be stored, in a vector database, in association with a corresponding full-text path and the search may be performed using the search query embedding, the first vector embeddings, and the second vector embeddings.

In some implementations, the method may further include querying a full-text database containing textual representations of the set of all API paths using the search query, and results of querying the vector database and the full-text database may be combined in order to output final search results for the search query.

In some implementations, the method may further include: generating third vector embeddings of one or more runtime defined API objects; querying an in-memory database containing the third vector embeddings, and results of querying the vector database, the full-text database, and the in-memory database may be combined in order to output final search results for the search query.

In some implementations, the results of querying the vector database and the full-text database may be combined based on determining a ranking of the results.

In some implementations, the method may further include generating fourth vector embeddings of textual representations of the set of all API paths, and the search may be performed using the search query embedding, the first vector embeddings, the second vector embeddings, and the fourth vector embeddings.

In another aspect, the present application discloses a computing system. The computing system includes a processor and a memory coupled to the processor. The memory stores computer-executable instructions that, when executed by the processor, may cause the processor to: receive a search query for a first application programming interface (API); generate an embedding of the search query; perform a search of the first API by using the search query embedding to search a set of first vector embeddings generated by: obtaining API schema of the first API; determining a set of all API paths associated with the first API based on the API schema, each API path defining a root API object and a sequence of one or more field elements of the API ending in a terminal field element; obtaining, using a large language model (LLM), natural language descriptions of each API path associated with the first API; and generating the first vector embeddings based on the obtained descriptions, and provide results of the search, the results identifying one or more API paths similar to the search query.

In another aspect, the present application discloses a non-transitory, processor-readable medium storing processor-executable instructions that, when executed by a processor, may cause the processor to: receive a search query for a first application programming interface (API); generate an embedding of the search query; perform a search of the first API by using the search query embedding to search a set of first vector embeddings generated by: obtaining API schema of the first API; determining a set of all API paths associated with the first API based on the API schema, each API path defining a root API object and a sequence of one or more field elements of the API ending in a terminal field element; obtaining, using a large language model (LLM), natural language descriptions of each API path associated with the first API; and generating the first vector embeddings based on the obtained descriptions, and provide results of the search, the results identifying one or more API paths similar to the search query.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” is used to describe a machine learning model. A generative AI model may sometimes be referred to, or may use, a language learning model. A trained generative AI model may respond to an input prompt by generating and producing an output or result. The output/result may be generated by the generative AI model through interpreting the intent and context of the prompt. In some cases, the generative AI model may be implemented with constraints on the acceptable prompts. In some cases, this may include a prompt template. A prompt template may specify that prompts have a certain structure or constrained intents, or that acceptable prompts exclude certain classes of subject matter or intent, such as the production of results or outputs that are violent, pornographic, etc.

Significant advances have been made in recent years in generative AI models. Different implementations may be trained to create digital art, computer code, conversation text responses, or other types of outputs. Examples of generative AI models include Stable Diffusion by Stability AI Ltd., ChatGPT by OpenAI, DALL-E 2 by OpenAI, and GitHub CoPilot by GitHub and OpenAI. The models are typically trained using a large data set of training data. For instance, in the case of AI for generating images, the training data set may include a database of millions of images tagged with information regarding the contents, style, artist, context, or other data about the image or its manner of creation. The generative AI trained on such a data set is then able to take an input prompt in text form, which may include suggested topics, features, styles or other suggestions, and provide an output image that reflects, at least to some degree, the input prompt.

### Searching API Data

Finding the right data (e.g., an object field and its value) in an API can be challenging. Users may need to have comprehensive knowledge of the API or directly search/query the API docs, for example, by creating database queries. For new or unsophisticated users of the API, this may be a tall order. Moreover, traditional API searches are limited to exact keyword matching, without consideration of semantic similarities.

API searches may impose a further layer of complication. Even if a user knows the particular name of a variable (e.g., a method name or an object attribute/field) that they are looking for, a search of the API using said variable name as a search term may return multiple matches with different meanings. For example, API docs of an e-commerce API may define an object type, Order. When a user searches the API docs for the term “name”, the search results may include multiple different parent “nodes” containing child “nodes” that match said search term (e.g., order.fulfillments.name, order.location.city.name, etc.).

The present application discloses a system and methods for performing search of API data. As a specific example, the disclosed techniques can be employed to locate a variable, such as a method name or an object attribute/field defined for an API. At runtime, the set of variables that are in scope at a particular point of execution make up the “environment”. The environment changes as execution proceeds, since the set of in-scope variables changes. When writing executable code, a developer may desire to declare a variable and to assign a particular value to the declared variable. The potential sources for the value include the variables that are in scope. A search may be performed over the in-scope variables to examine their properties and sub-properties. The developer may, for example, provide search term(s) describing the value that they are looking for. The search should identify a variable of the API matching the developer's search criteria/term(s); a value referenced by the identified variable may then be assigned, by the developer, to the declared variable.

The proposed system leverages both semantic and lexical searches of API data. Given an API, the system scans the schema of the API to catalog all possible “API paths”. An API path defines the API operations that are available on a single path. An API operation may, for example, be an access operation for accessing the value of a field of an API object. Each API path ends in a specific “terminal” element, i.e., a leaf node variable (which may be a method name, field, attribute, connection, etc.) In particular, an API path specifies a single terminal element (e.g., order.id) or a set of one or more elements (e.g., order.customer.address.city) that are traversed to reach a terminal element. Identifying and documenting all potential API paths creates a comprehensive map of the available data within the API.

Once the API schema has been parsed, the system generates descriptions for the identified API paths. The system leverages use of large language models (LLMs) to generate a concise, natural language description for each API path. The description of an API path may, for example, be a summary of relationship(s) between the constituent elements of the path. An LLM may be instructed to generate a suitable description for each API path based on, at least, the API definitions/descriptions and/or other metadata associated with components of the path.

In at least some implementations, the system also generates one or more candidate search queries. The candidate search queries represent predicted query terms or phrases that may be used for locating an object/field. For example, the API path “order.lineItems.product.title” may be associated with the natural language description of “the title of the product related to the order's line items”. Candidate search queries for the API path might include “order item product name”, “title of product of order item”, “order's item product title”, and the like. The system may use the same LLM or different LLMs when generating the path descriptions and the predicted candidate search queries.

The system then generates embeddings of the descriptions (and candidate search queries). The generated embeddings are indexed to the corresponding full-text API path. For example, each embedding may be stored in a vector database in association with its corresponding full-text API path. Alternatively, in some implementations, the system may also generate (and store) embeddings of the full-text API paths. The full-text API paths may be stored, for example, in a full-text database.

The API paths may be indexed at the time when a user performs a search (i.e., online), or they may be indexed ahead of time (i.e., offline) and the indexed data may be stored in a database for fast retrieval later when a search is performed. When a user inputs a search query, the query is transformed into a vector embedding. The user query vector embedding is then compared to the indexed embeddings, i.e., embeddings of the path descriptions and/or candidate search queries, using a vector similarity search algorithm. Based on the comparison, the system may identify the most similar API path(s) to the user query.

In some implementations, the user query may be used to query both the vector database and the full-text database. That is, the search pipeline may comprise a combination of a vector database query and a full-text database query. The results of the queries, i.e., similar API paths to the user query, may be ranked by a ranking component. In some implementations, the system may generate embeddings for runtime defined types and store the generated embeddings in an in-memory vector database. The user query may then be compared to the embeddings of the in-memory vector database to identify similar API paths to the user query. The ranking component may be trained and fine-tuned, and in some implementations, may encode certain preferences (e.g., shorter paths are more likely to be picked over longer paths).

In some implementations, the system may update the candidate search queries based on detecting that the embedding of the user query resulting in an API path search result is above a distance threshold from the embedding of the candidate search queries.

The disclosed techniques may be employed in the context of integrated development environments (IDEs). Specifically, the value search techniques may be used to support code completion features of IDEs. By way of example, a user can input, into an IDE, one or more search terms and/or semantic description of what the user is looking for (in an API) during software code development, and the search algorithm may return a suitable variable, e.g., a method name or an object attribute/field. A code completion feature of the IDE may then automatically fill in a code input area using the variable. In this way, the disclosed techniques may enable developers to navigate data structures when using an IDE.

To illustrate additional details regarding the methods and systems of the present application, some concepts relevant to generative AI models, neural networks, and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train an ML model that is intended to classify images, the training dataset may be a collection of images. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

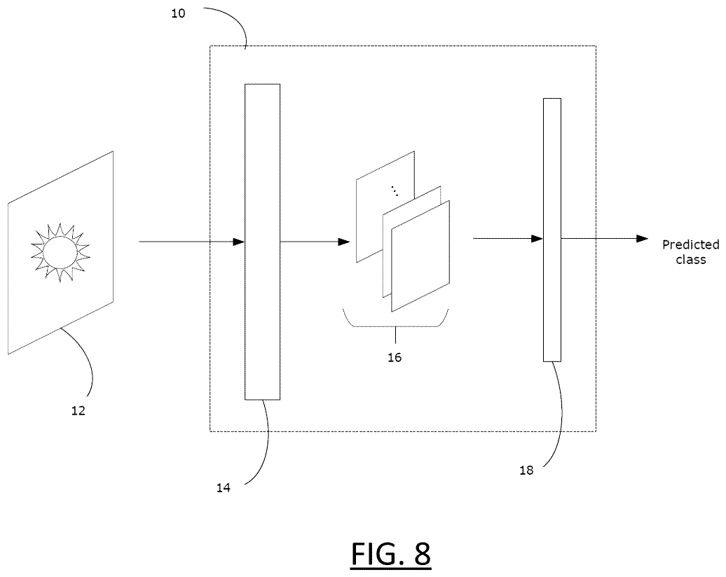

FIG. 8 is a simplified diagram of an example convolutional neural network (CNN) 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to an ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model”encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

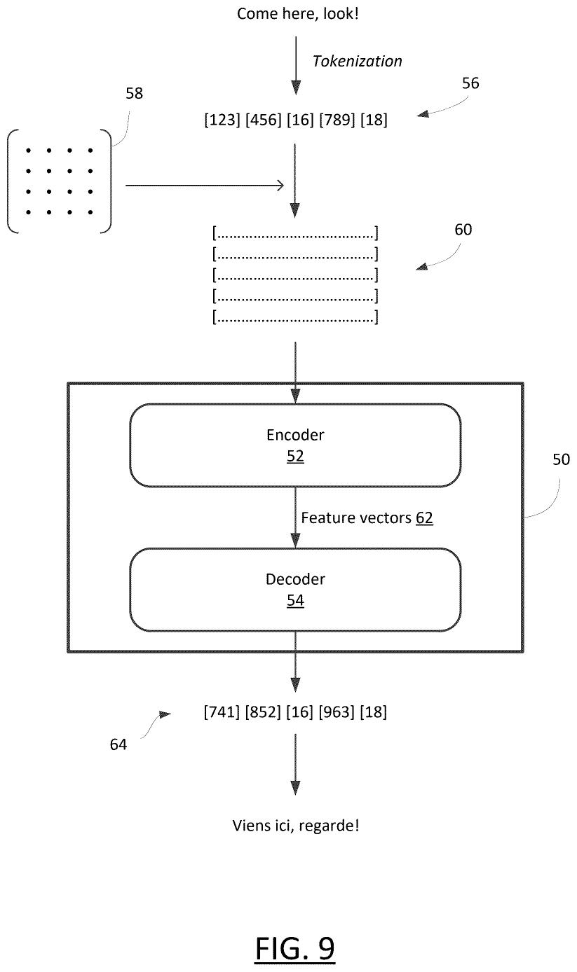

FIG. 9 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 9, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 9 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

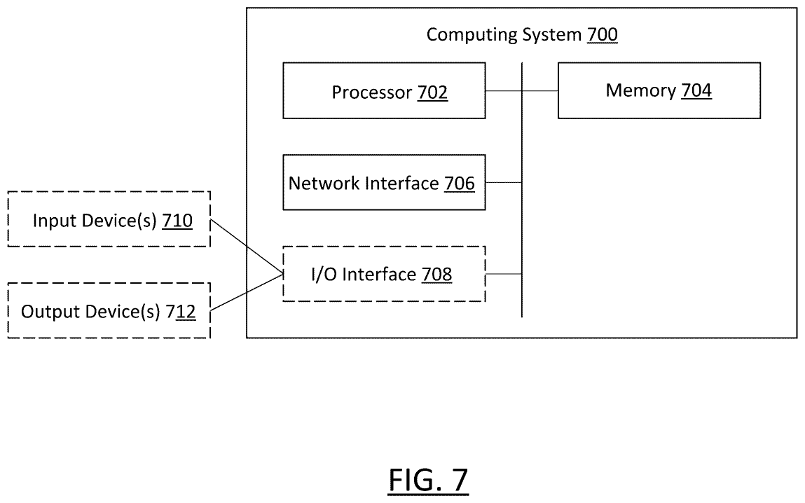

FIG. 7 illustrates an example computing system 700, which may be used to implement examples of the present disclosure, such as a prompt generation engine to generate prompts to be provided as input to a language model such as an LLM. Additionally, or alternatively, one or more instances of the example computing system 700 may be employed to execute the LLM. For example, a plurality of instances of the example computing system 700 may cooperate to provide output using an LLM in manners as discussed above.

The example computing system 700 includes at least one processing unit, such as a processor 702, and at least one physical memory 704. The processor 702 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 704 may include a volatile or non-volatile memory (e.g., a flash memory, a random-access memory (RAM), and/or a read-only memory (ROM)). The memory 704 may store instructions for execution by the processor 702, to the computing system 700 to carry out examples of the methods, functionalities, systems and modules disclosed herein.

The computing system 700 may also include at least one network interface 706 for wired and/or wireless communications with an external system and/or network (e.g., an intranet, the Internet, a P2P network, a WAN and/or a LAN). A network interface may enable the computing system 700 to carry out communications (e.g., wireless communications) with systems external to the computing system 700, such as a language model residing on a remote system.

The computing system 700 may optionally include at least one input/output (I/O) interface 708, which may interface with optional input device(s) 710 and/or optional output device(s) 712. Input device(s) 710 may include, for example, buttons, a microphone, a touchscreen, a keyboard, etc. Output device(s) 712 may include, for example, a display, a speaker, etc. In this example, optional input device(s) 710 and optional output device(s) 712 are shown external to the computing system 700. In other examples, one or more of the input device(s) 710 and/or output device(s) 712 may be an internal component of the computing system 700.

A computing system, such as the computing system 700 of FIG. 7, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

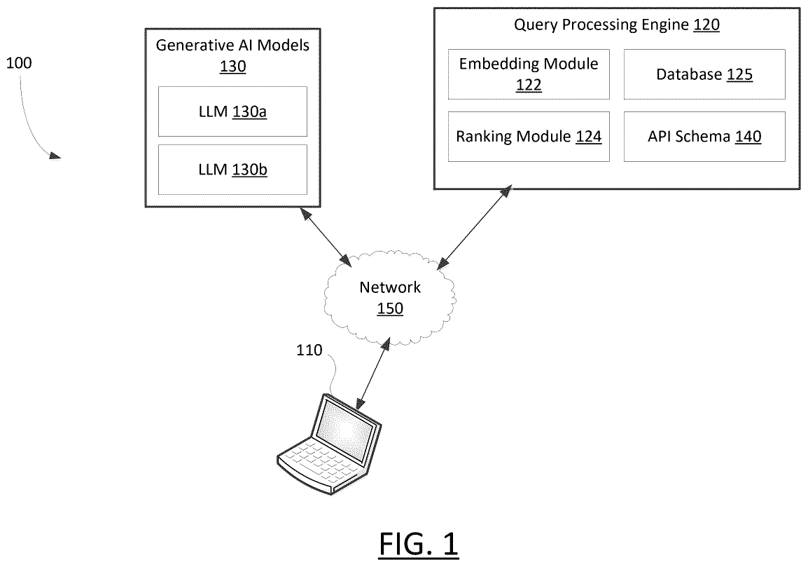

Reference is now made to FIG. 1, which illustrates, in block diagram form, an example computing environment 100 for implementing a query management system. The computing environment 100 may be implemented using one or more computing devices.

The computing environment 100 includes one or more computing devices 110, a query processing engine 120, an embedding module 122, a ranking module 124, a database 125, generative AI models 130 (including LLMs 130a, 130b), an API schema 140, and a network 150. It should be noted that the computing environment 100 may support other architectures; the illustrated architecture of FIG. 1 is but one possible embodiment. The generative AI models 130 may comprise a single machine learning (ML) model or a suite of multiple ML models, such as LLMs 130a and 130b. A generative AI model 130 is an unsupervised or semi-supervised machine learning algorithm that has been trained using a set of training data content. The generative AI model 130 may be a transformer 50, as described above. Input prompts may be provided to the generative AI model 130, and the model may produce outputs related to the input prompts. The generative AI model 130 may be a generative adversarial network, and/or a transformer-based model.

The query processing engine 120 is configured to receive user-supplied queries from computing devices 110 via the network 150. In the context of a code development platform, a user-supplied query may comprise a search query for an API variable. A search query includes plain text (i.e., words, phrases) that defines the user's information needs with respect to the development environment. The search query may be inputted by the user via a search interface, such as a GUI of an integrated development environment (IDE). For example, the user may initiate a value search of an API by inputting one or more keywords relating to an object, field, connection, etc. that they seek. As another example, a value search may be performed as part of executing a code completion function during active code development using an IDE. Code completion is an autocompletion feature that fixes common mistakes and suggests lines of code. When code completion software or feature within an IDE predicts code, a value search may be conducted to identify a relevant variable based on user input of source code into the IDE. An efficient search mechanism for locating variables enables real-time (or near real-time) generation of accurate code predictions.

Upon processing a query from a user, the query processing engine 120 may generate a suitable response. A response to a query may, for example, include at least one API variable matching the search query. The responses generated by the query processing engine 120 may be communicated to the computing devices 110 via the network 150. For example, a query response may be provided to a user device 120 for displaying on a graphical user interface associated with an IDE.

In at least some implementations, a user-supplied query may be modified by the query processing engine to generate a suitable prompt for inputting to the generative AI model 130. For example, an input prompt may be generated by adjusting a user-supplied query in accordance with one or more defined constraints associated with the generative AI model 130. The constraints may, for example, relate to restrictions (e.g., character limits, content filters, etc.) on acceptable prompts for the generative AI model 130.

The query processing engine 120 may be configured to perform searches of a relevant search space. The search may, for example, be a keyword search, a vector similarity search, or a hybrid search. The search space may comprise data sources, such as private or public repositories of data, document libraries, etc., or an embedding space corresponding to one or more such data sources. The query processing engine 120 may implement a suitable search algorithm which may depend, at least in part, on the type of requested search, the relevant search space, and/or the query data. As will be described in greater detail below, API paths data, embeddings of path descriptions and/or candidate search terms, metadata, search filters (e.g., for narrowing down search scope to limited number of API paths), etc. may be stored, for example, in database 125 accessible to the query processing engine 120, which supports keeping the search very fast at runtime.

The query processing engine 120 may index various data objects using vector embeddings. An embedding module 122 creates vector representations of data. Embeddings are computed using machine learning models. The embedding module 122 is configured to use one or more embedding models for processing different types of data. Examples of pre-trained embedding models which may be implemented include: Word2Vec, Doc2Vec, Universal Sentence Encoder, Global Vectors (GloVe), Embeddings from Language Models (ELMo), FastText, MobileNet v2, SentenceBERT, InferSent, etc.

The query processing engine 120 is configured to compute similarity between vectors in an embedding space. In particular, the query processing engine 120 may use one or more metrics for calculating vector similarity such as, but not limited to, L2 (Euclidean) distance, cosine similarity, and inner product (dot product). Various algorithms for vector similarity search may be implemented by the search engine. Examples include k-nearest neighbor (kNN), approximate nearest neighbors (ANN) search, space partition tree and graph (SPTAG), Faiss, and hierarchical navigable small world (HNSW).

In the context of API variable searches, vector embeddings may be generated based on search queries (search query embeddings) and plain text descriptions of API paths and/or candidate search queries (indexed embeddings). The API variable search may be executed by implementing a suitable vector similarity algorithm that compares an embedded search query with indexed embeddings. The search may produce results that identify one or more API paths similar to the search query.

In at least some implementations, the generative AI models 130 and the query processing engine 120 may be included in, or be accessed by, a query management system. That is, a query management system may implement various functions of the generative AI model 130 and the query processing engine 120. Additionally, or alternatively, a generative AI model 130 may comprise a hosted service, such as OpenAI, which can be accessed via the network 150. While FIG. 1 shows the generative AI model 130 and the query processing engine 120 as separate components of computing environment 100, it will be understood that the query processing engine 120 may be configured to implement various features of the generative AI model 130.

The network 150 is a computer network. In some implementations, the network 150 may be an internetwork such as may be formed of one or more interconnected computer networks. For example, the network 150 may be or may include an Ethernet network, an asynchronous transfer mode (ATM) network, a wireless network, or the like.

In some example implementations, the query processing engine 120 may be integrated as a component of an e-commerce platform. That is, an e-commerce platform may be configured to implement example embodiments of the query processing engine 120. In particular, the subject matter of the present application, including example methods for generating query responses, may be employed in the specific context of e-commerce. For example, the query processing engine 120 may be adapted to facilitate automatically handling queries from customers of an e-commerce platform.

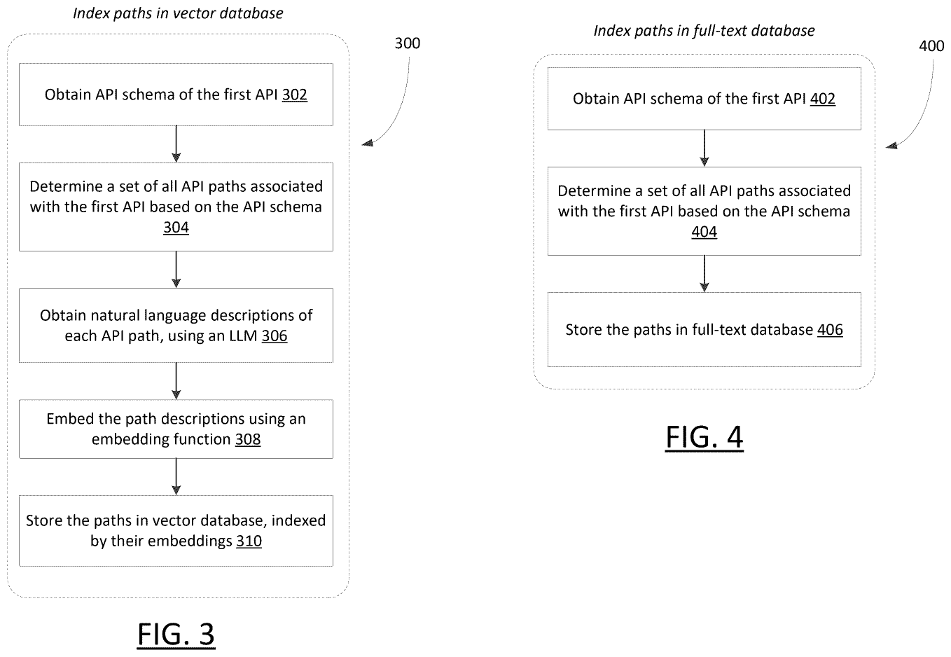

Reference is now made to FIG. 3, which shows, in flowchart form, an example method 300 for indexing API paths data of an API. Specifically, API paths data may be indexed in a vector database, in accordance with method 300. The method 300 may be implemented by a computing system that is configured to process API data of an API, such as the query processing engine 120 of FIG. 1.

The query processing engine obtains API schema of a first API, in operation 302. For example, the query processing engine may access a comprehensive API reference or developer documentation outlining the API schema. The API schema provides a structured, machine-readable representation of an API's endpoints, request and response structures (e.g., required or optional fields, headers), and validation rules (e.g., constraints on lengths, required formats, etc.). Additionally, or alternatively, the API schema may be exposed in a standardized format (for example, using OpenAPI Specification) and the schema file may be imported to an IDE or a different online tool. For APIs without clear documentation, a schema discovery tool may be used to define, discover, and/or visualize schemas.

In operation 304, the query processing engine determines a set of all API paths associated with the first API based on the API schema. More particularly, the API schema is parsed to identify all possible “API paths” of the first API. An API path consists of a starting API object and a sequence of one or more API field/attribute elements (which may also be objects defined in the API) that ends in a terminal element. An object in an API reference represents a structured entity, and fields are individual components of an object that define specific pieces of data. In graph-theoretical terms, an API path corresponds to a directed path that connects a finite sequence of distinct API objects/fields, from a starting vertex to an ending vertex in a specific order. Every defined object and field of the API is included in at least one API path. In at least some implementations, the set of all API paths may include only those paths ending in a terminal element that does not itself include any further fields (i.e., in graph-theoretical terms, a leaf node). Identifying and documenting every potential API path creates a comprehensive map of data defined for the first API.

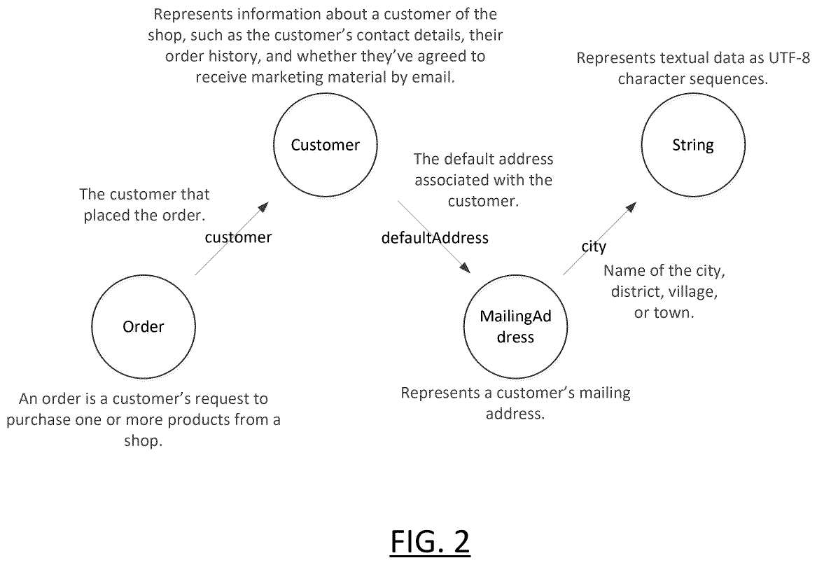

FIG. 2 shows a graphical representation of an example API path. The illustrated API path includes a root, or starting, object “order” (of object type Order) and a series of nested fields associated with said root object: “customer” of object type Customer; “defaultAddress” of object type MailingAddress, and “city” of type String. Each API path may be represented in textual format, by specifying the constituent elements of the path in accordance with the order defined by the API. That is, a textual representation of an API path comprises an ordered sequence of object/field names. For example, the API path of FIG. 2 may be expressed as order.customer.defaultAddress.city.

An API reference or developer documentation includes descriptions of objects and fields that are defined for the API. The description may provide explanations about the structure and purpose of the data represented by the object/field, and are useful for developers to understand how to interact with the API effectively. An object description may include the object type (e.g., Order), an explanation of what the object represents, usage context (i.e., where and how the object is used in the API), and relationships to other objects. A field description may include the field name, data type of the field, an explanation of what the field represents, constraints on the field (e.g., formatting requirements, character limits, etc.), and example values.

A description of an API path, then, represents a combination of the descriptions of the constituent objects and fields of the API path. In particular, the description may be a summary of the relationship(s) between constituent elements of the API path. The query processing engine obtains natural language descriptions of each API path associated with the first API (operation 306). More particularly, the query processing engine leverages a large language model (LLM) to generate the API path descriptions.

In at least some implementations, the query processing engine provides, as part of input prompts to the LLM, the set of all identified API paths for the first API and instructions to generate descriptions of the identified API paths. The input prompts may include textual representations of the constituent elements, i.e., ordered sequences of names of objects and fields, of the API paths. The instructions may specify how the LLM is to generate the descriptions. For each identified API path, the LLM may be instructed to retrieve, from an API reference or developer documentation (accessible by the LLM), descriptions of the constituent objects and fields of the path, and combine the retrieved descriptions to generate a succinct description for the path. The inputs to the LLM may also include constraints on the descriptions (e.g., character or word limits, etc.) and/or indicator of desired complexity of descriptions.

In operation 308, the query processing engine embeds the API path descriptions. More particularly, the query processing engine generates indexed vector embeddings based on the obtained descriptions. Once the LLM outputs the descriptions corresponding to the identified API paths of the first API, the generated API path descriptions are used to create embeddings. For example, an embedding engine/function may create a vector embedding for each API path description.

In some implementations, for each API path, the query processing engine may also determine one or more candidate search queries relating to the API path. The candidate search queries are determined using an LLM, which may be the same or different from the LLM that is instructed to generate the natural language descriptions of the API paths. The candidate search queries represent predicted query terms or phrases that may be used for locating an object/field. For example, the API path “order.lineItems.product.title” may be described as, i.e., associated with the description, “the title of the product related to the order's line items”. Example candidate search queries might include “order item product name”, “title of product of order item”, “order's item product title”, and the like. The query processing engine may instruct the LLM to generate a defined number of candidate search queries based on textual representations of the API paths. For example, the LLM may be instructed to output potential search queries that may be used to locate a variable (i.e., a terminal “node” or element) represented by an API path.

The candidate search queries may also be embedded. In particular, the query processing engine may generate vector embeddings based on the candidate search queries, in addition to the natural language descriptions of the API paths. More specifically, the query processing engine may generate first vector embeddings of path descriptions of the API paths and second vector embeddings of the one or more candidate search queries associated with the API paths.

In operation 310, the API paths data is stored in a vector database, indexed by their embeddings. Each generated vector embedding may be stored, in the vector database, in association with (textual representation of) a corresponding API path. By way of example, a generated vector embedding (i.e., embedded API path description, candidate search query) may be stored in a vector database and associated, in the database, with a textual representation of the corresponding API path, such as an ordered sequence of names of constituent objects and fields. The vector embeddings of the API path descriptions may be indexed using data structures or techniques like KD-Tree, Approximate Nearest Neighbors, etc. for faster search.

FIG. 4 illustrates another example method 400 for indexing API paths data of an API. Specifically, API paths data may be indexed in a full-text database, in accordance with method 400. In operation 402, a query processing engine obtains API schema of a first API. The set of all API paths associated with the first API may then be determined based on the API schema (operation 404). The API paths data can then be stored in a full-text database, in operation 406. In particular, a textual representation of each API path of the first API may be stored in the full-text database. The operations of method 400 may be performed in a similar manner as corresponding operations of method 300.

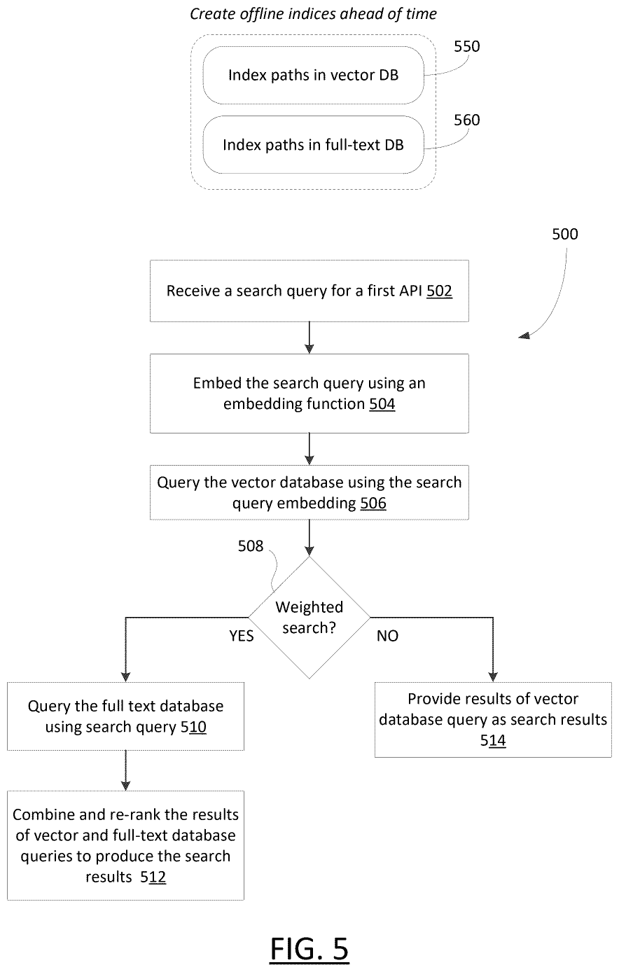

As described above with reference to FIGS. 3 and 4, the API paths of an API can be indexed in a vector database (550) and/or a full-text database (560). The “indices” may be created prior to performing searches of API data, i.e., created offline ahead of time. At search time, the vector and full-text databases, either individually or collectively, may be queried to obtain the search results. Reference is now made to FIG. 5, which shows, in flowchart form, an example method 500 for performing search of API data using offline indexing. The method 500 may be implemented by a computing system that is configured to handle incoming search queries for a software development environment, such as the query processing engine 120 of FIG. 1. In particular, a query processing engine that performs searches of API data, such as API documentation, and outputs relevant search results may perform the operations of method 500. The operations of method 500 may be performed in addition to, or as alternatives of, one or more of the operations of methods 300 and 400.

A query processing engine receives a search query for a first API, in operation 502. The search query comprises text (e.g., words, phrases) that a user provides in order to find information regarding the first API. More specifically, the search query is a query for locating a variable of the first API that matches user-supplied text. The user may supply search terms and/or a semantic description of what the user is looking for during code development. In some implementations, the search query may be received via a graphical user interface of an IDE. For example, the graphical user interface may include input fields associated with a search functionality, and the search query may be received via the input fields.

The search query may include indication of the first API, or the first API may be inferred to be the environment for search based on code context. By way of example, a search functionality of the IDE may enable a user to input selection of one or more APIs to search. As another example, the IDE may be configured to determine the API(s) in use by analyzing source code. In particular, the IDE may recognize libraries, frameworks, or external services in the codebase and determine the identity of the API. The codebase may also be analyzed to identify any imported modules or libraries, or package metadata. Additionally, or alternatively, the IDE may infer API usage from function signatures, types, and interfaces, or by analyzing runtime behavior. Some IDEs may integrate directly with API specifications; for example, an IDE may load API schemas (e.g., GraphQL, etc.) to provide context and autocompletion for API calls. The IDE suggests API endpoints, parameters, and expected responses as the user writes code.

In operation 504, the query processing engine embeds the search query. In at least some implementations, the query processing engine generates a vector embedding of the search query. The search query may be provided to an embedding engine/function to create the vector embedding, or search query embedding. The search query embedding is generated from the text of the search query. For example, the search query embedding may be generated using an OpenAI™ embeddings call (or a different embedding model).

The query processing engine then performs a search of the first API data by using the search query embedding to query the vector database, in operation 506. In some implementations, the query may be performed by comparing the search query embedding to the indexed vector embeddings using a vector similarity search algorithm. The similarity or distance between the search query embedding and all or a subset of the indexed embeddings is computed. The search results identify one or more API paths of the first API that are similar to the search query.

For example, the search results may include a set of a predefined number of closest (most similar) vectors, ranked by similarity. As another example, the query processing engine may identify a first one of the API paths having the highest likelihood to contain a field element corresponding to the search query. The first API path may correspond to a first indexed vector embedding that is determined to be most similar to the search query embedding based on the vector similarity search. The vector similarity search produces results that include a list of the most similar vectors, similarity scores associated with the indexed vector embeddings, and metadata tied to the vectors.

In some implementations, the variable search of the first API may be performed as a weighted search that contemplates results of queries of indexed vector embeddings as well as textual representations of the API paths of the first API. Upon detecting selection of an option to perform a weighted search (508), the query processing engine queries the full-text database (containing the textual representations of the API paths) using the search query (operation 510). As previously explained, the textual representation of an API path may comprise an ordered sequence of names of objects and fields that make up the API path, beginning with a starting object and ending with a terminal object/field.

In some implementations, the results of querying the vector database and the full-text database may be combined based on determining a ranking of the results. In particular, a ranking (or re-ranking) of the search results may be generated by comparing first query results of querying the vector database corresponding to the most similar API paths to the search query and second query results of querying the full-text database corresponding to textual representations that “match” the search query terms (operation 512).

On the other hand, if weighted search is not selected, the query processing engine simply returns results of the vector database query as the search results (operation 514). That is, the search is performed by comparing the search query embedding with the indexed vector embeddings, but without obtaining results of querying the full-text database.

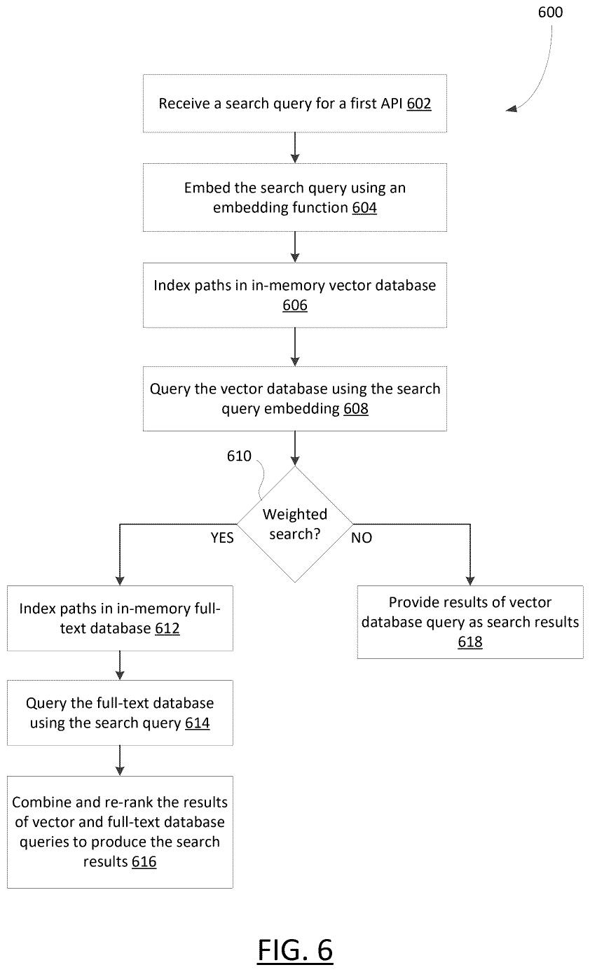

As an alternative to offline indexing, the API paths of a given API may be indexed in real-time when a search of API data is performed (i.e., online indexing). Reference is now made to FIG. 6, which shows, in flowchart form, an example method 600 for performing search of API data using online indexing. The method 600 may be implemented by a computing system that is configured to handle incoming search queries for a software development environment, such as the query processing engine 120 of FIG. 1. In particular, a query processing engine that performs searches of API data, such as API documentation, and outputs relevant search results may perform the operations of method 600. The operations of method 600 may be performed in addition to, or as alternatives of, one or more of the operations of methods 300, 400, and 500.

A query processing engine receives a search query for a first API, in operation 602. The search query comprises text (e.g., words, phrases) that a user provides in order to find information regarding the first API. More specifically, the search query is a query for locating a variable of the first API that matches user-supplied text. The user may supply search terms and/or a semantic description of what the user is looking for during code development. In some implementations, the search query may be received via a graphical user interface of an IDE. For example, the graphical user interface may include input fields associated with a search functionality, and the search query may be received via the input fields.

The search query may include indication of the first API, or the first API may be inferred to be the environment for search based on code context. By way of example, a search functionality of the IDE may enable a user to input selection of one or more APIs to search. As another example, the IDE may be configured to determine the API(s) in use by analyzing source code. In particular, the IDE may recognize libraries, frameworks, or external services in the codebase and determine the identity of the API. The codebase may also be analyzed to identify any imported modules or libraries, or package metadata. Additionally, or alternatively, the IDE may infer API usage from function signatures, types, and interfaces, or by analyzing runtime behavior. Some IDEs may integrate directly with API specifications; for example, an IDE may load API schemas (e.g., GraphQL, etc.) to provide context and autocompletion for API calls. The IDE suggests API endpoints, parameters, and expected responses as the user writes code.

In operation 604, the query processing engine embeds the search query. In at least some implementations, the query processing engine generates a vector embedding of the search query. The search query may be provided to an embedding engine/function to create the vector embedding, or search query embedding. The search query embedding is generated from the text of the search query. For example, the search query embedding may be generated using an OpenAI™ embeddings call (or a different embedding model).

The API paths are then indexed in an in-memory vector database, in operation 606. In particular, the embeddings of the API paths may be created in real-time when a search is performed and stored in the in-memory vector database.

The query processing engine then performs a search of the first API data by using the search query embedding to query the vector database, in operation 608. In some implementations, the query may be performed by comparing the search query embedding to the indexed vector embeddings using a vector similarity search algorithm. The similarity or distance between the search query embedding and all or a subset of the indexed embeddings is computed. The search results identify one or more API paths of the first API that are similar to the search query.

For example, the search results may include a set of a predefined number of closest (most similar) vectors, ranked by similarity. As another example, the query processing engine may identify a first one of the API paths having the highest likelihood to contain a field element corresponding to the search query. The first API path may correspond to a first indexed vector embedding that is determined to be most similar to the search query embedding based on the vector similarity search. The vector similarity search produces results that include a list of the most similar vectors, similarity scores associated with the indexed vector embeddings, and metadata tied to the vectors.

In some implementations, the variable search of the first API may be performed as a weighted search that contemplates results of a query of indexed vector embeddings as well as textual representations of the API paths of the first API. Upon detecting selection of an option to perform a weighted search (610), the query processing engine indexes textual representations of the API paths in an in-memory full-text database (operation 612) and then queries the full-text database using the search query (operation 614). That is, the API paths are indexed, in the full-text database, in real-time when the search is performed.

In some implementations, the results of querying the vector database and the full-text database are combined based on determining a ranking of the results. In particular, a ranking of the search results may be generated by comparing first query results of querying the vector database corresponding to the most similar API paths to the search query and second query results of querying the full-text database corresponding to text representations that “match” the search query terms (operation 616).

On the other hand, if weighted search is not selected, the query processing engine simply returns results of the vector database query as the search results (operation 618). That is, the search is performed by comparing the search query embedding with all of the indexed vector embeddings, but without obtaining results of querying the full-text database.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some implementations, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
receiving a search query for a first application programming interface (API);
generating an embedding of the search query;
performing a search of the first API by using the search query embedding to search a set of first vector embeddings generated by:
obtaining API schema of the first API;
determining a set of all API paths associated with the first API based on the API schema, each API path defining a root API object and a sequence of one or more field elements of the API ending in a terminal field element;
obtaining, using a large language model (LLM), natural language descriptions of each API path associated with the first API; and
generating the first vector embeddings based on the obtained descriptions, and
providing results of the search, the results identifying one or more API paths similar to the search query.

2. The method of claim 1, wherein performing the search comprises comparing the search query embedding to the first vector embeddings using a vector similarity search algorithm.

3. The method of claim 1, further comprising storing, in a vector database, each first vector embedding in association with a corresponding full-text path.

4. The method of claim 1, wherein performing the search comprises identifying a first one of the API paths with the highest likelihood to contain a field element corresponding to the search query.

5. The method of claim 1, wherein the search query is received via a graphical user interface of an integrated development environment.

6. The method of claim 1, further comprising:
for each API path, determining, using an LLM, one or more candidate search queries relating to the API path; and
generating second vector embeddings of the candidate search queries, wherein each first vector embedding and second vector embedding is stored, in a vector database, in association with a corresponding full-text path and wherein the search is performed using the search query embedding, the first vector embeddings, and the second vector embeddings.

7. The method of claim 6, further comprising querying a full-text database containing textual representations of the set of all API paths using the search query, wherein results of querying the vector database and the full-text database are combined in order to output final search results for the search query.

8. The method of claim 7, further comprising:
generating third vector embeddings of one or more runtime defined API objects;
querying an in-memory database containing the third vector embeddings, wherein results of querying the vector database, the full-text database, and the in-memory database are combined in order to output final search results for the search query.

9. The method of claim 7, wherein the results of querying the vector database and the full-text database are combined based on determining a ranking of the results.

10. The method of claim 6, further comprising:
generating fourth vector embeddings of textual representations of the set of all API paths,
wherein the search is performed using the search query embedding, the first vector embeddings, the second vector embeddings, and the fourth vector embeddings.

11. A computing system, comprising:
a processor;
memory coupled to the processor, the memory storing computer-executable instructions that, when executed by the processor, configure the processor to:
receive a search query for a first application programming interface (API);
generate an embedding of the search query;
perform a search of the first API by using the search query embedding to search a set of first vector embeddings generated by:
obtaining API schema of the first API;
determining a set of all API paths associated with the first API based on the API schema, each API path defining a root API object and a sequence of one or more field elements of the API ending in a terminal field element;
obtaining, using a large language model (LLM), natural language descriptions of each API path associated with the first API; and
generating the first vector embeddings based on the obtained descriptions, and
provide results of the search, the results identifying one or more API paths similar to the search query.

12. The computing system of claim 11, wherein performing the search comprises comparing the search query embedding to the first vector embeddings using a vector similarity search algorithm.

13. The computing system of claim 11, wherein the instructions, when executed, configure the processor to store, in a vector database, each first vector embedding in association with a corresponding full-text path.

14. The computing system of claim 11, wherein performing the search comprises identifying a first one of the API paths with the highest likelihood to contain a field element corresponding to the search query.

15. The computing system of claim 11, wherein the search query is received via a graphical user interface of an integrated development environment.

16. The computing system of claim 11, wherein the instructions, when executed, configure the processor to:
for each API path, determine, using an LLM, one or more candidate search queries relating to the API path; and
generate second vector embeddings of the candidate search queries, wherein each first vector embedding and second vector embedding is stored, in a vector database, in association with a corresponding full-text path and wherein the search is performed using the search query embedding, the first vector embeddings, and the second vector embeddings.

17. The computing system of claim 16, wherein the instructions, when executed, further configure the processor to query a full-text database containing textual representations of the set of all API paths using the search query, wherein results of querying the vector database and the full-text database are combined in order to output final search results for the search query.

18. The computing system of claim 17, wherein the instructions, when executed, further configure the processor to:
generating third vector embeddings of one or more runtime defined API objects;
querying an in-memory database containing the third vector embeddings, wherein results of querying the vector database, the full-text database, and the in-memory database are combined in order to output final search results for the search query.

19. The computing system of claim 17, wherein the results of querying the vector database and the full-text database are combined based on determining a ranking of the results.

20. A non-transitory, computer-readable medium storing instructions that, when executed by a processor, configure the processor to:
receive a search query for a first application programming interface (API);
generate an embedding of the search query;
perform a search of the first API by using the search query embedding to search a set of first vector embeddings generated by:
obtaining API schema of the first API;
determining a set of all API paths associated with the first API based on the API schema, each API path defining a root API object and a sequence of one or more field elements of the API ending in a terminal field element;
obtaining, using a large language model (LLM), natural language descriptions of each API path associated with the first API; and
generating the first vector embeddings based on the obtained descriptions, and
provide results of the search, the results identifying one or more API paths similar to the search query.
